(19) United States
(12) Patent Application Publication
(10) Pub. No.: US 2018/0297173 A1
(43) Pub. Date: Oct. 18, 2018

(54) Methods of Polishing

(71) Applicant: HEWLETT-PACKARD DEVELOPMENT COMPANY, L.P., HOUSTON, TX (US)

(72) Inventors: KUAN-TING WU, TAIPEI CITY (TW); CHI HAO CHANG, TAIPEI CITY (TW); YU-CHUAN KANG, TAIPEI CITY (TW)

(21) Appl. No.: 15/519,700

(22) PCT Filed: Apr. 7, 2015
(86) PCT No.: PCT/US2015/024623

§ 371 Date: Apr. 17, 2017

(51) Int. Cl. B24D 3/34; B24C 11/00; C25D 5/42; C25D 13/20; C25D 13/04; C09D 5/44; C09G 1/02; C09K 3/14

(52) U.S. Cl. CPC B24D 3/346; B24C 11/00; C25D 5/42; C25D 13/20; C09K 3/14; C09D 5/4473; C09D 5/4457; C09D 5/4411; C09G 1/02; C25D 13/04

(57) ABSTRACT

One example provides a method. The method includes forming a substrate comprising a metal alloy comprising at least one of aluminium, magnesium, lithium, zinc, titanium, niobium, and copper. The method includes polishing a surface of the substrate using particles comprising chromium metal. The polished surface is electrically conductive.

### BACKGROUND

Polishing may be employed to smooth surface of a workpiece. Polishing generally ernploys using an abrasive and a work wheel or a leather strop. In one example, polishing refers to processes that involve an abrasive that is glued to the work wheel. Polishing may remove stress concentrators present in the rough surface, and as a result, the strength of a polished product may be higher than the rougher counterpart. The stress concentrators may take the form of corners and other defects (e.g., pits) which may magnify the local stress beyond the mechanical strength of the material.

### BRIEF DESCRIPTION OF THE DRAWINGS

The drawings are provided to illustrate various examples of the subject matter described herein related to methods of polishing and are not intended to limit the scope of the subject matter. The drawings are not necessarily to scale.

FIG. 1 shows a flowchart illustrating one example of a method described herein.

FIG. 2 shows a flowchart illustrating another example of a method described herein.

FIG. 3 shows a flowchart illustrating another example of a method described herein.

### DETAILED DESCRIPTION

In general, metal substrate surfaces are blasted or polished by sand (including silica, SiO₂), silicon carbide, or alumina (Al₂O₃). However, silica and alumina are electrically non-conductive. Thus, silica and alumina particles trapped inside of metal substrate pinholes may cause non-uniform electrical conductivity on the substrate surface because of the non-electrically conductive particle contamination thereon.

In view of the aforementioned challenges related to the polishing process, the inventors have recognized and appreciated the advantages of a polishing process using certain material. Following below are more detailed descriptions of various examples related to a polishing process, particularly one using chromium metal. The various examples described herein may be implemented in any of numerous ways.

Provided in one aspect is a method, comprising: forming a substrate comprising a metal alloy comprising at least one of aluminium, magnesium, lithium, zinc, titanium, niobium, and copper; and polishing a surface of the substrate using particles comprising chromium metal, wherein the polished surface is electrically conductive.

Provided in another aspect is a method comprising: forming a substrate comprising a magnesium alloy; polishing a surface of the substrate using particles comprising chromium metal, wherein the polished surface is electrically conductive; and disposing a coating over the polished surface using at least an electrical current.

Provided in another aspect is a method comprising; forming a substrate comprising a magnesium alloy; polishing a surface of the substrate using particles comprising chromium metal, wherein the polished surface is electrically conductive; treating the polished surface by one of cleaning and surface activation; disposing a first layer comprising a transition metal over the treated surface using electrodeposition; treating the first layer with surface activation; disposing a second layer over the treated first layer using electrophoretic deposition; and creating a functional coating over the second layer.

The methods described herein may involve using chromium (metal) powder particles or chromium (metal) slurry to polish a surface of a metal-containing substrate. In one example, the polishing takes place before the substrate is subjected to additional surface process(es), such as a coating process by, for example, electrodeposition, electrophoretic deposition, etc. In one example, the methods described herein produce polished metal-containing substrate having a uniform cosmetic surface layer and homogeneous electrical conductivity on the substrate surface.

Depending on the application, any suitable material may be employed in the methods of manufacturing described herein. The metal material (of the substrate) may comprise a pure metal, a metal alloy, an intermetallic, a metallic compound, or a metal-containing composite. Note that the substrate may comprise one single layer of the metal material or may comprise multiple layers of the same of different materials, at least some of which is the metal material. The metal material may comprise at least one of aluminium, magnesium, lithium, zinc, titanium, niobium, iron, and copper. In one example, an iron-containing metal material is steel, such as stainless steel. In one example, the metal material comprises magnesium or an alloy thereof. In one example, the metal material is a magnesium alloy. The metal material may comprise an alloy of any of the aforementioned metal elements or a combination of any of the aforementioned metal elements.

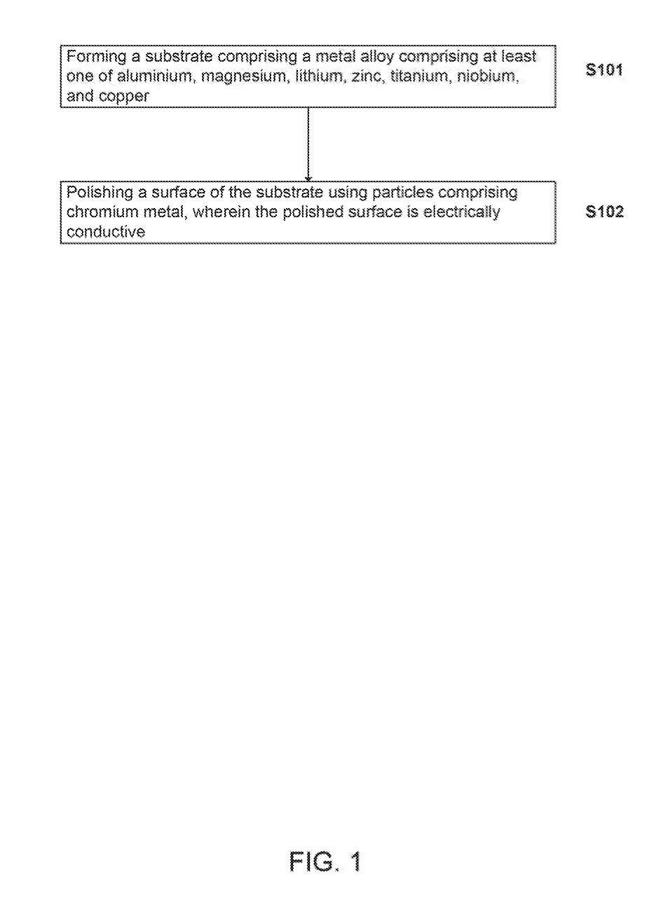

FIG. 1 describes the processes involved in one example of a method described herein. The method may comprise forming a substrate comprising a metal alloy comprising at least one of aluminium, magnesium, lithium, zinc, titanium, niobium, and copper (S101). In one example, the substrate comprises a magnesium alloy. Depending on the application, the methods of forming/manufacturing described herein may involve various processes as a part of, or other than, those described herein. In one example, the substrate is formed by any suitable method, such as one involving at least one of computer numerical control machining (“CNC”) (e.g., computer controlled cutting) and forging. The parameters of the processes may vary depending on the materials and processes involved.

As shown in FIG. 1, the method may further comprise polishing a surface of the substrate using particles comprising chromium metal, wherein the polished surface is electrically conductive (S102). The surface may be uniformly and homogeneously electrically conductive across the surface. “Polishing” herein may encompass both mechanical polishing and blasting the surface. Mechanical polishing may involve using an abrasive and a work wheel or a leather strop on a surface of a substrate to reduce roughness of the surface. The abrasive may be disposed (e.g., detachably) over the work wheel (e.g., a sand paper) and the surface to be polished is in contact with the abrasive as the wheel revolves. Blasting (or “blast cleaning”) may involve mechanical cleaning by the continuous impact of abrasive particles at relatively high velocities on to the steel surface either in a jet stream of compressed air or by centrifugal impellers. The latter method may involve a relatively large stationary equipment fitted with radial bladed wheels onto which the abrasives are fed. As the wheels revolve at a relatively high speed, the abrasives are thrown onto the steel surface, the force of impact being determined by the size of the wheels and their radial velocity. In one example, blasting may involve several wheels (e.g. 4 to 8) to treat all the surfaces of the steel being cleaned. The abrasives are recycled with separator screens to remove fine particles. This process may be efficient (e.g., 100% efficient) to remove mill scale and rust.

The particles used in the polishing process may comprise chromium metal. In one example, the particles may consist essentially of chromium metal. In one example, the particles may consist of chromium metal. It is noted that the term “chromium metal” herein may encompass a minute amount of inevitable impurities, such as oxide thereof, but the amount is generally less than or equal to about 10 wt %—e.g., less than or equal to about 5 wt %, about 2 wt %, about 1 wt %, about 0.5 wt %, about 0.2 wt %, about 0.1 wt %, or lower. In one example, the polishing particles are at least substantially free of at least one of silica, silicon carbide, and alumina. The particles may have any suitable geometry, including shape and size. For example, the particles may be spherical, cubical, cylindrical, flake-like, irregular, etc. The term “size” herein may refer to an average in the case of a plurality of particles. Also, the term “Size” may refer to length, width, height, diameters, etc., of the particles depending on the geometry. In one example, the particles have an (average) size that is less than or equal to about 5 mm—e.g., less than or equal to about 2 mm, about 1 mm, about 0.5 mm, about 0.2 mm, about 0.1 mm, about 50 μm, about 20 μm, about 10 μm, about 1 μm, or smaller. The polishing may involve subjecting the surface to be polished to abrasives of various sizes in sequence (e.g., in descending order), such that the smoothness of the surface increases as the size of the polishing abrasives decreases.

Using chromium as the polishing (abrasive) agent may provide the polished surface with more uniform electrical conductivity, in comparison to pre-existing polishing method of using silica, alumina, or silicon carbides. This benefit is particularly evident in a magnesium alloy. Not to be bound by any particular theory, but these beneficial results may be attributed to the relatively high hardness of chromium metal—chromium metal has Mohs hardness up to 8.5, in comparison with Mg (2.5), Zn (2.5), Li (0.6), Al (3.0), MgO (4), Li₂O (2.0), and ZnO (4.5). Chromium is also resistant to corrosion, such as chemical corrosion. The uniform electrical conductivity at the surface as a result of polishing with chromium may facilitate additional processes for the substrate, including electrodeposition, electrophoretic deposition, and the like. Additionally, polishing with chromium (metal) particles may reduce the risk of bubble formation, in contrast to the pre-existing polishing with silica, silicon carbides, or alumina particles, the silica and alumina particles known to cause bubble issue.

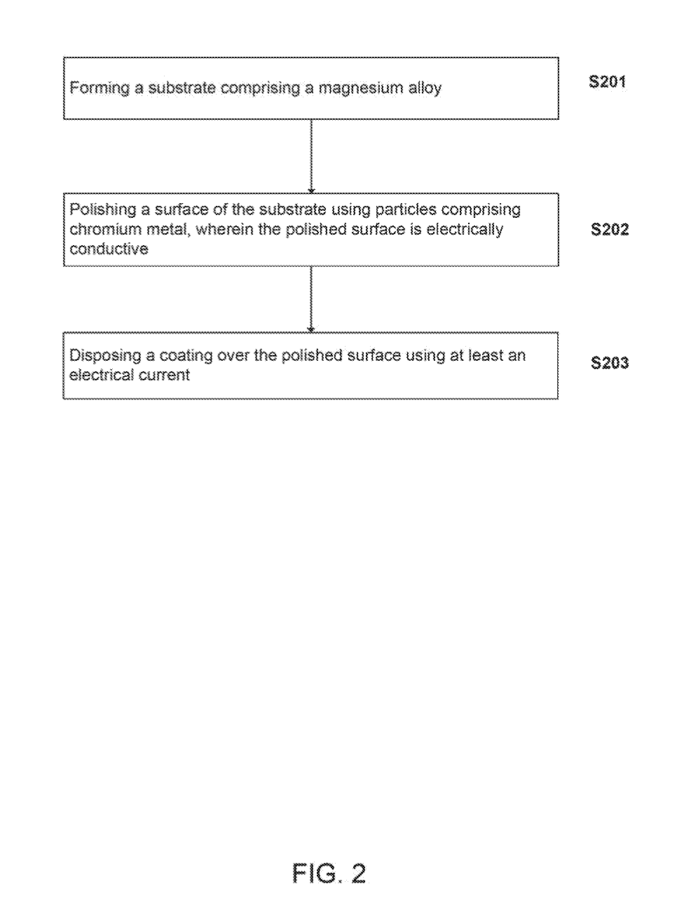

FIG. 2 shows the processes involved in another example of the method described herein. The method may comprise forming a substrate comprising a magnesium alloy (S201). The formation may be any of those described herein. The method may further comprise polishing a surface of the substrate using particles comprising chromium metal (S202). The polished surface may be electrically conductive. The polishing may involve any of the processes described herein. The method may further comprise disposing a coating over the polished surface using at least an electrical current (S203).

FIG. 2 shows the processes involved in another example of the method described herein. The method may comprise forming a substrate comprising a magnesium alloy (S301). The formation may be any of those described herein. The method may further comprise polishing a surface of the substrate using particles comprising chromium metal (S302). The polished surface may be electrically conductive. The polishing may involve any of the processes described herein. The method may further comprise treating the polished surface by one of cleaning and surface activation (S303). Both cleaning and surface activation, in any combination, may be employed. The treatment may be any of those described herein. The method may further comprise disposing a first layer comprising a transition metal over the treated surface using electrodeposition (S304). The electrodeposition will be described further below. The method may further comprise treating the first layer with surface activation (S305). The surface activation is described further below. Additionally, the method may further comprise disposing a second layer over the treated first layer using electrophoretic deposition (S306). Finally, the method may further comprise creating a functional coating over the second layer (S307)

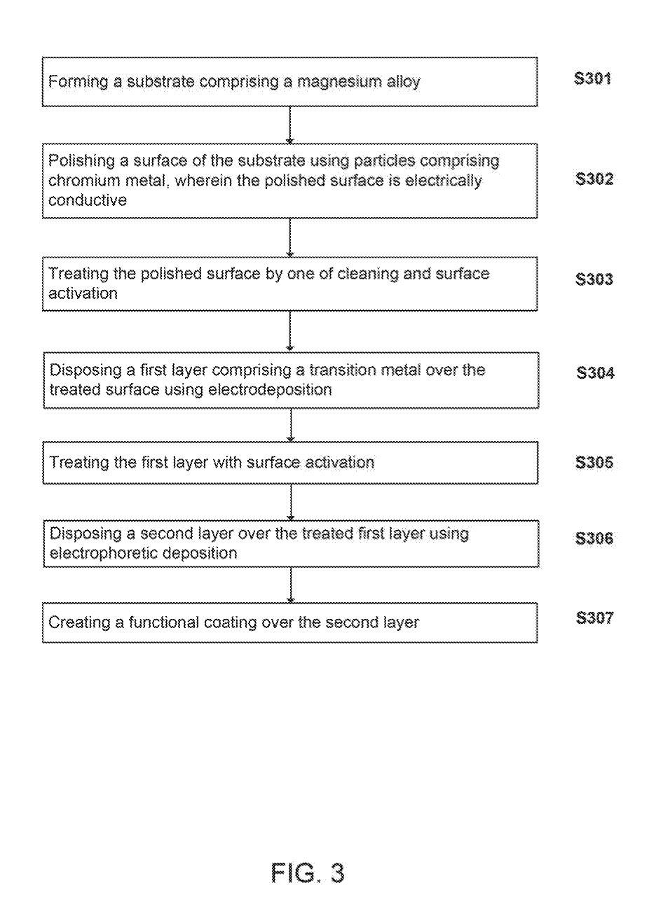

The methods described herein, such as any of those shown in FIGS. 1-3 may further include additional processes. For example, the method may further comprise treating the polished surface with an agent. Any suitable treatment may be employed. The agent may refer to any suitable material employed to facilitate the respective treatment process. The treatment may involve at least one of cleaning and surface activation. Cleaning may involve, for example, degreasing. The degreasing may involve application of pressure, solvent, temperature, etc., depending on the materials involved, to remove oil from the surface. Surface activation may involve exposing the first surface to a bath before the oxidation. The bath may be acidic or alkaline.

The method may further comprise disposing a coating over the treated surface. The disposing may involve any suitable deposition process. For example, the disposing may involve using at least an electrical current. For example, the disposing may involve electrodeposition. Any suitable material may be deposited using electrodeposition. For example, the material may be a metal or a metal alloy. The metal may refer to a transition metal. In one example, the electrodeposition involves electroplating a transition metal on the substrate, such as the polished surface of the substrate. The transition metal may comprise at least one of aluminium, zinc, copper, chromium, and nickel. Other materials may also be used.

The disposing may involve electrophoretic deposition. The term “electrophoretic deposition” (“ED”) herein may encompass a number of known industrial processes, including electrocoating, e-coating, cathodic electrodeposition, anodic electrodeposition, and electrophoretic coating, and electrophoretic painting. An ED method may involve any suitable number of processes and any suitable number of materials. For example, ED may involve disposing colloidal particles suspended in a liquid medium using an electric field over an electrically conducive surface. The electrically conductive surface may be that of an electrode. In one example, the migration of particles using the influence of an electric field is known as electrophoresis.

ED may involve aqueous processes or non-aqueous processes. The processes and the processing parameters may vary, depending on the materials involved. ED may be versatile with respect to the type of material being disposed over a substrate. In general, any colloidal particles that may be employed to form stable suspensions and that may carry an electrical charge may be employed in ED. In one example, the substrate over which the material is disposed using ED is electrically conductive. For example, the material suitable for ED may include polymers, pigments, dyes, ceramics, metals, etc. The type of suitable material may also depend on whether it is a cathodic or an anodic material for the ED. In one example, the material to be disposed over a substrate comprises at least one of polyacrylic polymer, epoxy-based polymer, and nanoparticles. In one example, the material to be disposed by ED comprises one of polyacrylic and epoxy. In another example, nanoparticles are added to the polymer to be disposed by ED to control the surface profile, color performance, or both. The nanoparticles may comprise a metal, a compound (e.g., a metal oxide, such as silica). In another example, the material to be disposed by ED comprises a dye.

The methods of manufacturing described herein may further comprise disposing a functional coating layer over the polished and treated substrate. In one example, the functional coating is disposed over a layer created by electrophoretic deposition. The functional coating may be disposed by any suitable technique. For example, the functional coating may be disposed using spray coating or dipping the surface over which the functional coating is to be formed into a bath to coat the surface with the functional coating material.

The functional coating may be any suitable type of coating, depending on the application desired. For example, the functional coating may be one of: protective coating, anti-finger print coating, soft touch coating, anti-bacterial coating, anti-smudge coating, and insulation coating. In one example, the functional coating may provide soft touch feeling, particularly when the coating comprises polyurethane.

Depending on the application, the functional coating may comprise any suitable material. For example, the functional coating may comprise a hydrophobic material. For example, the functional coating may comprise at least one polymer. The polymer may be one of, for example, polystyrene, polyimide, polyarelene ether, polyurethane, methylsilsesquioxane, polyethylene, polystyrene silicone, butyl rubber, polyamide, polycarbonate, styrene-butadiene rubber, polyacrylate, epoxy, and fluoropolymer. Other types of polymers are also possible. In one example wherein the polymer is a polyimide, the polymer is fluorinated polyimide, polyvinyl chloride polyimide, or Kapton (available from E. I. du Pont de Nemours andi Company, USA). In one example wherein the polymer is a polyamide, the polymer is nylon. In one example wherein the polymer is a polystyrene, the polymer is acrylonitrile butadiene styrene (“ABS”). In one example, the functional coating comprises polyurethane.

In addition to aforementioned polymers, the functional coating may also comprise other types of materials, including an anti-bacterial agent, a filler, etc. A filler may be any suitable material, depending on the application. The filler may be an organic material or an inorganic material. For example, the filler may be a ceramic. Examples of a suitable filler may include carbon black, titanium dioxide, clay, mica, talc, barium sulfate, calcium carbonate, synthetic pigment, metallic powder, aluminum oxide, an organic powder, an inorganic powder, graphene, graphite, and dispersed elastomers.

The equipment that may be employed for the manufacturing methods described herein is not limited. As long as the equipment may perform the processes as described herein, the equipment may be used.

The methods of manufacturing described herein may further comprise post-deposition process(es), after an ED coating layer is formed on the substrate. Any suitable post-processing processes may be employed. For example, after the ED coating layer is formed, the methods of manufacturing may further comprise rinsing at least the coated surface of the substrate and dehydrating at least the rinsed coated surface. The rinsing may involve any suitable rinsing agent, such as those described above. The dehydration may involve any suitable process, depending on the application. Examples of dehydration may be the application of heat, air, or both.

The methods of manufacturing described herein may further comprise inspection of the product after a particular process. An inspection may involve any quality control process. An inspection process may be applied after any of the processes described herein is completed. In one example, an inspection process is employed for the substrate after at least one of the cutting (e.g., diamond cutting) and ED processes.

### Applications

Due at least in part to the numerous aforedescribed desirable properties, the housing structure described herein may be employed in various applications. For example, the housing structure may be an integral part of a structural component. The component may be a part of the housing of an electronic device. A housing of a device may refer to any structural component that encloses the interior of the device. In one example, the housing structure described herein is a part of the housing of an electronic device. For example, the housing structure may be any part of the housing, including back cover, front cover, side cover, and the like, of the device.

An electronic device herein may refer to any device comprising at bast one electrical circuit. Thus, in one example, the housing that comprises the housing structure described herein may be external to the electrical circuit. The electronic device may be a consumer electronic device. An electronic device may refer to portable/mobile electronic device. An electronic device herein may refer to a computer, a memory storage, a display, a signal transmitting device, and the like. A computer may refer to a desktop, a laptop, a tablet, a phablet, a tablone, and the like. A storage unit may refer to the hardware of a hard drive, a server, a processor, and the like. A display may refer to a monitor, a liquid crystal display (“LCD”), a television, and the like. A signal transmitting device may refer to a device transmitting any type of signal, including light, sound, heat, and the like. In one example, the electronic device is a mobile phone.

### Additional Notes

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The indefinite articles “a” and “an” as used herein in this disclosure, including the claims, unless clearly indicated to the contrary, should be understood to mean “at least one.” Any ranges cited herein are inclusive.

The terms “substantially” and “about” used throughout this disclosure, including the claims, are used to describe and account for small fluctuations. For example, they may refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Concentrations, amounts, and other numerical data may be expressed or presented herein in a range format. Such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “1 weight % (wt %) to 5 wt %” should be interpreted to include not only the explicitly recited values of 1 wt % to 5 wt %, but also include individual values and sub-ranges within the indicated range. Thus, included in this numerical range are individual values, such as 2, 3, 5, and 4, and sub-ranges, such as from 1-3, from 2-4, and from 3-5, etc. This same principle applies to ranges reciting only one numerical value. Furthermore, such an interpretation should apply regardless of the breadth of the range or the characteristics being described.

As used in this disclosure, including the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in this disclosure, including the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including elements other than B); in another example, to at least one, optionally including more than one, B, with no A present (and optionally including elements other than A); in yet another example, to at least one, optionally including more than one, A, and at least one, optionally including more than one, B (and optionally including other elements); etc.

In this disclosure, including the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, § 2111.03.

What is claimed:

1. A method comprising:
forming a substrate comprising a metal alloy comprising at least one of aluminium, magnesium, lithium, zinc, titanium, niobium, and copper; and
polishing a surface of the substrate using particles comprising chromium metal, wherein the polished surface is electrically conductive.

2. The method of claim 1,wherein the substrate comprises a magnesium alloy.

3. The method of claim 1, wherein the forming comprises at least one of forging and computer numerical control machining.

4. The method of claim 1, wherein the polishing comprises at least one of mechanically polishing and blasting the surface with the particles.

5. The method of claim 1, further comprising:
treating the polished surface with an agent; and
disposing a coating over the treated surface.

6. The method claim 1, wherein the particles are at least substantially free of at least one of silica, silicon carbide, and alumina.

7. A method comprising:
forming a substrate comprising a magnesium alloy;
polishing a surface of the substrate using particles comprising chromium metal, wherein the polished surface is electrically conductive; and
disposing a coating over the polished surface using at least an electrical current.

8. The method of claim 7, further comprising treating the polished by at least one of:
cleaning the surface; and
activating the surface for the disposing.

9. The method of claim 7, wherein the disposing comprises electroplating a transition metal over the polished surface.

10. The method of claim 7, wherein the disposing comprises electroplating a transition metal over the polished surface, the transition metal comprising at least one of aluminium zinc, copper, chromium, and nickel.

11. The method of claim 7, wherein the disposing comprises electrophoretic deposition.

12. The method of claim 7, wherein the disposing comprises electrophoretic deposition using a east one of a polyacrylic polymer and an epoxy-based polymer.

13. The method of claim 7, wherein the coating is a functional coating comprising at least one polymer selected from the group consisting of polystyrene, polyimide, polyarelene ether, polyurethane, methylsilsesquioxane, polyethylene, polystyrene silicone, butyl rubber, polyamide, polycarbonate, styrene-butadiene rubber, polyacrylate, epoxy, and fluoropolymer.

14. A method comprising:
forming a substrate comprising a magnesium alloy;
polishing a surface of the substrate using particles comprising chromium metal, wherein the polished surface is electrically conductive;
treating the polished surface by one of cleaning and surface activation;
disposing a first layer comprising a transition metal over the treated surface using electrodeposition;
treating the first layer with surface activation;
is disposing a second layer over the treated first layer using electrophoretic deposition; and
creating a functional coating over the second layer.

15. The method, of claim 14, wherein the polishing comprises a least one of mechanically polishing and blasting the surface with the particles.
